(19) United States
(12) Patent Application Publication
(10) Pub. No.: US 2011/0206395 A1
(43) Pub. Date: Aug. 25, 2011

(54) IMAGE FORMING APPARATUS AND CONTROL METHOD THEREOF

(75) Inventors: Sumito Tanaka, Tokyo (JP); Tadashi Fukuda, Toride-shi (JP); Masahiro Makino, Toride-shi (JP)

(73) Assignee: CANON KABUSHIKI KAISHA, Tokyo (JP)

(21) Appl. No.: 13/020,225

(22) Filed: Feb. 3, 2011

(30) Foreign Application Priority Data
Feb. 24, 2010 (JP) 2010-039200

(51) Int. Cl. G03G 15/00; G03G 15/043; G03G 15/01; G03G 15/08

(52) U.S. Cl. 399/46; 399/51; 399/223; 399/298; 399/53

(57) ABSTRACT

This invention provides an image forming apparatus, which attains a uniform gloss level of an overall image by preventing regions having different gloss levels from being generated on the image to be formed upon execution of image formation using a transparent toner, and a control method thereof. To accomplish this, an image forming apparatus of this invention identifies pixels to be developed using only a black toner of colored toners from an image signal of an image to be formed on a printing material upon execution of image formation using the transparent toner. Furthermore, the image forming apparatus executes exposure control so as to perform development using the transparent toner in an amount required to reduce a gloss level difference between the pixels to be developed using only the black toner and those to be developed using the colored toners other than the black toner.

### BACKGROUND OF THE INVENTION

1. Field of the Invention

The present invention relates to an image forming apparatus and a control method thereof.

2. Description of the Related Art

In recent years, in image forming apparatuses such as copying machines and printers using an electrophotography method, an apparatus that forms an image using a transparent toner in addition to colored toners such as cyan, magenta, yellow, and black toners is known. In such image forming apparatus, heating and fixing toner images formed on a printing material by combining the colored toners and transparent toner, for example, can adjust a gloss level of an image formed on the printing material.

As an image forming apparatus that adjusts the gloss level of an image in this way, methods described in Japanese Patent Laid-Open Nos. 9-200551, 6-222646, and 2004-70010 have been proposed. Japanese Patent Laid-Open No. 9-200551 has proposed an image forming apparatus which adjusts the gloss level of an image fixed on a printing material by adjusting a toner amount per unit area (to be also referred to as an “amount of applied toner” hereinafter) of the transparent toner in accordance with the amounts of applied colored toners on the image formed on the printing material.

Also, Japanese Patent Laid-Open No. 6-222646 has proposed an image forming apparatus that applies the transparent toner to other dots so that dots having a maximum toner amount and other dots have the same toner amount after toner images are formed on an image carrier. In this image forming apparatus, since a color image on the image carrier after the toner amount adjustment is transferred onto a printing material and is fixed, the gloss levels of the color image on the printing material are adjusted to be equal to each other.

Furthermore, Japanese Patent Laid-Open No. 2004-70010 has proposed an image forming apparatus which sets a fixing condition in a thermal fixing device in accordance with a printing material to be used, so that a gloss level difference as a difference between maximum and minimum gloss levels on an image fixed on the printing material by the thermal fixing device is equal to or smaller than a predetermined value. As described in Japanese Patent Laid-Open No. 2004-70010, an image having a uniform gloss level within an identical image plane can be formed independently of printing materials.

However, the aforementioned related arts suffer the following problems. For example, gloss levels on a color image formed on a printing material are often uneven depending on the types and amounts of toners to be used. In general, since the black toner is normally used for a text part included in the color image, the gloss level of the black toner is suppressed for the purpose of improving visibility of a text. On the other hand, since the color toners other than the black toner are normally used for a graphic part such as a photo and illustration included in the color image, the gloss level of the color toners is enhanced for the purpose of improving the appearance and impression. However, when the graphic part of the color image formed on the printing material under the same fixing condition has a gloss level difference between the color toners and black toner, regions having different gloss levels are generated on the single printing material. As a result, an unnatural image for the user who views the color image is unwantedly formed. The image forming apparatuses disclosed in Japanese Patent Laid-Open Nos. 9-200551, 6-222646, and 2004-70010 above cannot cope with such problem, and it is difficult to adjust a gloss level of an image formed on a printing material to a desired gloss level.

### SUMMARY OF THE INVENTION

The present invention has been made in consideration of the above problems, and provides an image forming apparatus which can prevent regions having different gloss levels from being generated on an image to be formed, and can attain a uniform gloss level on the entire image upon forming an image using a transparent toner.

One aspect of the present invention provides an image forming apparatus comprising: an image carrier; an exposure unit that exposes the image carrier in accordance with an image signal of an image to be formed on a printing material to form an electrostatic latent image on the image carrier; a plurality of first developing units that respectively develop the electrostatic latent images using different colored developing materials to form developing material images on the image carrier; a second developing unit that develops the electrostatic latent image using a transparent developing material, which is used to gloss an image to be formed on the printing material using the colored developing materials, to form a developing material image on the image carrier; an identifying unit that identifies, from the image signal, pixels to be developed using only a black developing material of the plurality of colored developing materials; an exposure control unit that controls an exposure amount of the exposure unit so as to develop the identified pixels by the second developing unit using the transparent developing material in an amount required to reduce a gloss level difference between the pixels to be developed using only the black developing material and pixels to be developed using the colored developing materials other than the black developing material; and a transfer unit that transfers a plurality of developing material images formed by the plurality of first developing units and a developing material image formed by the second developing unit from the image carrier to the printing material to be superposed with each other.

Another aspect of the present invention provides a control method of an image forming apparatus which comprises an image carrier, an exposure unit that exposes the image carrier in accordance with an image signal of an image to be formed on a printing material to form an electrostatic latent image on the image carrier, a plurality of first developing units that respectively develop the electrostatic latent images using different colored developing materials to form developing material images on the image carrier, and a second developing unit that develops the electrostatic latent image using a transparent developing material, which is used to gloss an image to be formed on the printing material using the colored developing materials, to form a developing material image on the image carrier, the method comprising: identifying, from the image signal, pixels to be developed using only a black developing material of the plurality of colored developing materials; controlling an exposure amount of the exposure unit so as to develop the identified pixels by the second developing unit using the transparent developing material in an amount required to reduce a gloss level difference between the pixels to be developed using only the black developing material and pixels to be developed using the colored developing materials other than the black developing material; and transferring a plurality of developing material images formed by the plurality of first developing units and a developing material image formed by the second developing unit from the image carrier to the printing material to be superposed with each other.

According to the present invention, the image forming apparatus which can prevent regions having different gloss levels from being generated on an image to be formed, and can attain a uniform gloss level on the entire image upon forming an image using a transparent toner can be provided.

Further features of the present invention will become apparent from the following description of exemplary embodiments (with reference to the attached drawings).

### BRIEF DESCRIPTION OF THE DRAWINGS

FIG. 1 is a view showing an example of the arrangement of an image forming apparatus 100 according to the first embodiment;

FIG. 2 is a block diagram showing an example of the arrangement of devices associated with image processing in a reader image processor 108 according to the first embodiment;

FIG. 3 is a block diagram showing an example of the arrangement of devices associated with image processing in a printer controller 109 according to the first embodiment;

FIG. 4 is a graph showing an example of gradation reproduction characteristics of the image forming apparatus 100 according to the first embodiment;

FIG. 5 is a graph showing an example of the relationship between the amounts of applied toners and gloss levels when plain paper is used in the image forming apparatus 100;

FIG. 6 is a flowchart showing the sequence of gloss level control in the image forming apparatus 100 according to the first embodiment;

FIG. 7 is a graph showing the relationship between the signal value of an image signal and the amount of applied transparent toner in the image forming apparatus 100 according to the first embodiment;

FIG. 8 is a graph showing an example of the relationship between the amounts of applied toners and gloss levels when coated paper is used in the image forming apparatus 100;

FIG. 9 is a graph showing an example of the relationship between the amounts of applied toners and gloss levels when cast-coated paper is used in the image forming apparatus 100;

FIG. 10 is a flowchart showing the sequence of gloss level control in an image forming apparatus 100 according to the second embodiment;

FIG. 11 is a view showing an example of the arrangement of a gloss level measurement unit 50 according to the second embodiment;

FIG. 12 is a view showing an example of gloss level measurement positions on a printing material according to the second embodiment;

FIG. 13 is a graph showing the relationship between the gloss level and amount of applied toner on a printing material according to the second embodiment;

FIG. 14 is a schematic view showing two-dimensional image information to be processed by a printer controller 109 according to the third embodiment; and

FIG. 15 is a diagram showing an example of the arrangement associated with text/line drawing determination processing in an image area determination unit 220 according to the third embodiment.

### DESCRIPTION OF THE EMBODIMENTS

Embodiments of the present invention will be described hereinafter. The embodiments to be described hereinafter will help understanding of various concepts such as broader concept, middle concept, and narrower concept of the present invention. Also, the technical scope of the present invention is settled by the scope of the claims, and is not limited by the following embodiments.

### First Embodiment

### Arrangement of Copying Machine 100

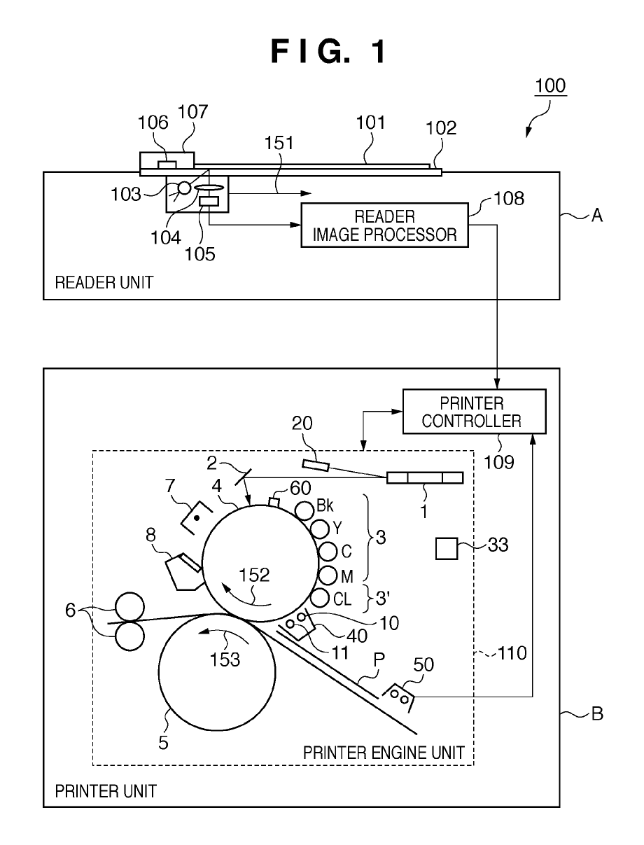

The first embodiment of the present invention will be described below with reference to FIGS. 1 to 7. This embodiment will exemplify a full-color digital copying machine (to be simply referred to as “copying machine” hereinafter) of an electrophotography method to which the present invention is applied. A copying machine 100 shown in FIG. 1 is an example of an image forming apparatus according to the present invention. The copying machine 100 roughly includes an image reading unit (reader unit A) which reads an image on a document, and converts the read image into image data, and an image forming unit (printer unit B) which forms (prints) an image on a printing material using image data. The copying machine 100 realizes a copy function of printing, on a printing material by the printer unit B, an image read by the reader unit A. Note that the copying machine 100 may have a printer function of printing image data, which is input from an external apparatus such as a PC via a network such as a LAN, on a printing material by the printer unit B.

(Reader Unit A)

A document 101 placed on a platen glass 102 of the reader unit A is irradiated with a laser beam emitted from a light source 103. Light reflected by the document 101 forms an image on a CCD sensor 105 via an optical system 104. The CCD sensor 105 includes a CCD line sensor group which is arranged in three lines corresponding to red, green, and blue, and generates red, green, and blue color component signals for respective line sensors. This reading optical system unit reads the document 101 while being moved in a direction of an arrow 151 shown in FIG. 1, thereby converting an image on the document 101 into electrical signals for respective lines.

A position alignment member 107 with which one side of the document 101 is brought into contact to prevent a skew placement of the document 101, and a reference white plate 106 which is used to decide a white level of the CCD sensor 105 and to perform shading correction of the CCD sensor 105 in a thrust direction are arranged on the platen glass 102. An image signal output from the CCD sensor 105 undergoes image processing by a reader image processor 108, and is then sent to the printer unit B. The image signal then undergoes image processing (to be described later) by a printer controller 109.

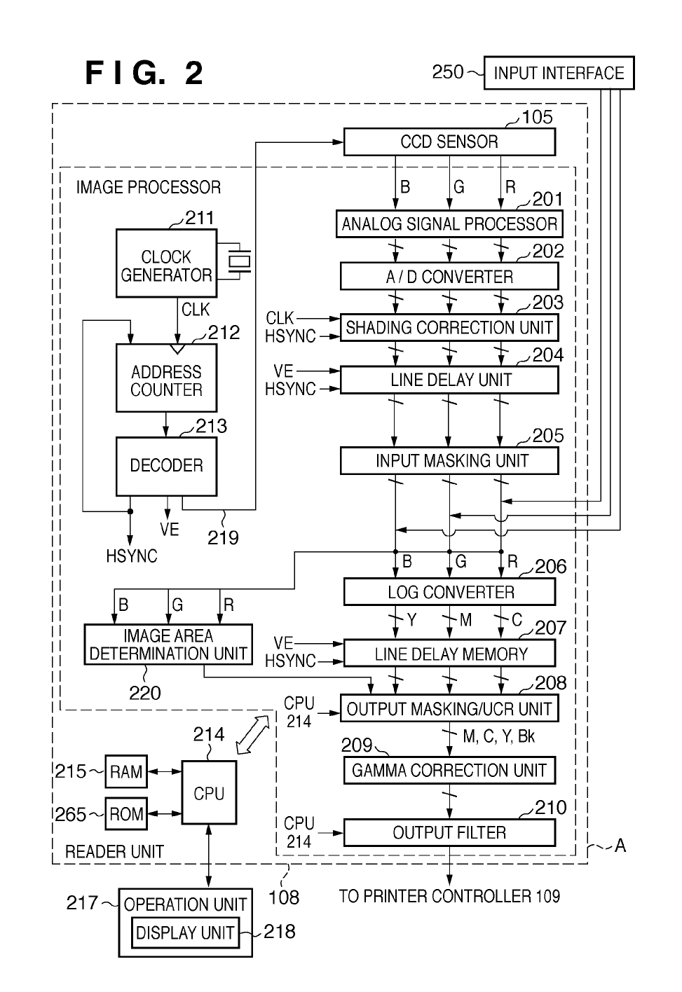

An example of the arrangement and operation of the reader image processor 108 of the reader unit A will be described below with reference to FIG. 2. The reader image processor 108 operates under the control of a CPU 214 of the reader unit A. To the CPU 214, a RAM 215 and ROM 216 are connected. The ROM 216 is a nonvolatile storage device that stores various control programs and image processing parameters. The RAM 215 is a volatile storage device that is mainly used as a work area of the CPU 214. The CPU 214 controls the operation of the overall reader unit A by reading out and executing programs stored in, for example, the ROM 216 onto the RAM 215.

Note that the reader unit A is also connected to an operation unit 217 in addition to the printer unit B. The operation unit 217 includes a user interface such as a keyboard and touch panel, and also a display unit 218 including a liquid crystal display. The operation unit 217 transfers a user instruction input via the user interface to the CPU 214. Also, the operation unit 217 makes displays associated with an operation mode and state of the copying machine 100 using the display unit 218.

As shown in FIG. 2, RGB analog image signals output from the CCD sensor 105 are input to an analog signal processor 201. The analog signal processor 201 adjusts the gains and offsets of the image signals, and then outputs the image signals to an analog/digital (A/D) converter 202. The A/D converter 202 converts the analog image signals into digital image data that are obtained by quantizing the analog image signals to, for example, 8 bits for respective RGB color components. The image signals including the image data for RGB color components output from the A/D converter 202 are input to a shading correction unit 203. The shading correction unit 203 applies shading correction to the input image signals using a signal obtained by reading the reference white plate 106, and outputs the corrected signals to a line delay unit 204. Note that the shading correction can be implemented by a known method.

A clock generator 211 generates clocks (CLK) for respective pixels. An address counter 212 counts the generated clocks CLK to generate a main scan address signal for each line, and outputs the main scan address signal to a decoder 213. The decoder 213 decodes the main scan address signal to generate a CCD driving signal such as a shift pulse and reset pulse for each line, a signal (VE) indicating a valid region in read signals for one line output from the CCD sensor 105, and a line synchronization signal (HSYNC). Note that when the address counter 212 is cleared by the signal HSYNC, it starts counting of a main scan address for the next line.

The line delay unit 204 corrects spatial deviations included in the image data output from the shading correction unit 203. The spatial deviations are caused since the line sensors for respective colors included in the CCD sensor 105 are parallelly arranged at predetermined intervals in the sub-scanning direction. More specifically, the line delay unit 204 delays image signals including image data of R and G components for respective lines in the sub-scanning direction with reference to an image signal including image data of a B component, thereby synchronizing phases of the signals corresponding to these three colors.

An input masking unit 205 converts a color space of the image data output from the line delay unit 204 into an NTSC standard color space. In this case, the color space of the signals of the respective color components output from the CCD sensor 105 depends on the spectral characteristics of filters of the respective color components. The input masking unit 205 converts the color space into the NTSC standard color space by converting the input image data using a matrix A based on the spectral characteristics, as given by:

$$( \begin{matrix}{R}_{0} \\ {G}_{0} \\ {B}_{0}\end{matrix} ) = \underbrace{( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} )}_{A} ( \begin{matrix}{R}_{i} \\ {G}_{i} \\ {B}_{i}\end{matrix} ) \qquad ( 1 )$$

where Rᵢ, Gᵢ, and Bᵢ are respective color components in input image data, and R₀, G₀, and B₀ are respective color components in image data to be output. Image data output from the input masking unit 205 are input to a LOG converter 206 and image area determination unit 220. In this case, when the aforementioned printer function is executed in place of the copy function in the copying machine 100, image data input from an external apparatus to the copying machine 100 via an input interface 250 are input to the LOG converter 206 and image area determination unit 220.

The light amount/density converter (LOG converter) 206 includes a storage device such as a ROM used to store a predetermined lookup table (LUT). The LOG converter 206 converts input image data (luminance data) of RGB color components into density data of magenta (M), cyan (C), and yellow (Y) components using the LUT. The converted data are output to a line delay memory 207. Note that the line delay memory 207 delays the image signals output from the LOG converter 206 by a period (line delay) in which the image area determination unit 220 generates control signals UCR, FILTER, SEN, and the like (to be described below) using the outputs from the input masking unit 205.

On the other hand, the image area determination unit 220 generates the control signals UCR, FILTER, SEN, and the like using the outputs from the input masking unit 205. In this case, the control signal UCR is used to control an output masking/UCR unit 208. The control signal FILTER is used by an output filter 210 to perform edge emphasis. The control signal SEN is used to enhance a resolution when the image area determination unit determines a black text part. The respective control signals output from the image area determination unit 220 are input to the output masking/UCR unit 208.

The output masking/UCR unit 208 extracts image data corresponding to a black component (Bk) from the image data output from the line delay memory 207. Furthermore, the output masking/UCR unit 208 executes a matrix operation required to correct any color turbidity of developing materials (toners) of the printer unit B for image data corresponding to M, C, Y, and Bk. After that, the output masking/UCR unit 208 sequentially outputs the image data of the M, C, Y, and Bk components as, for example, 8-bit data each time the reading operation of the reader unit A is performed. Note that the CPU 214 sets coefficients of a matrix used in this unit in advance.

A gamma correction unit 209 executes density correction to the image data output from the output masking/UCR unit 208 to be matched with ideal gradation characteristics in the printer unit B. The output filter (spatial filter processor) 210 applies edge emphasis or smoothing processing to the image data output from the gamma correction unit 209 based on a control signal from the CPU 214.

The image signal including the image data of the M, C, Y, and Bk color components, which have undergone the aforementioned image processing in the reader image processor 108, is sent to the printer controller 109. The printer controller 109 executes pulse-width modulation (PWM) based on the image signal input from the reader unit A, and prints an image on a printing material.

(Printer Unit B)

Referring back to FIG. 1, the arrangement of the printer unit B will be described below. The printer unit B roughly includes the printer controller 109 and a printer engine unit 110. The printer engine unit 110 operates under the control of the printer control unit 109. The arrangement of the printer engine unit 110 will be firstly described below.

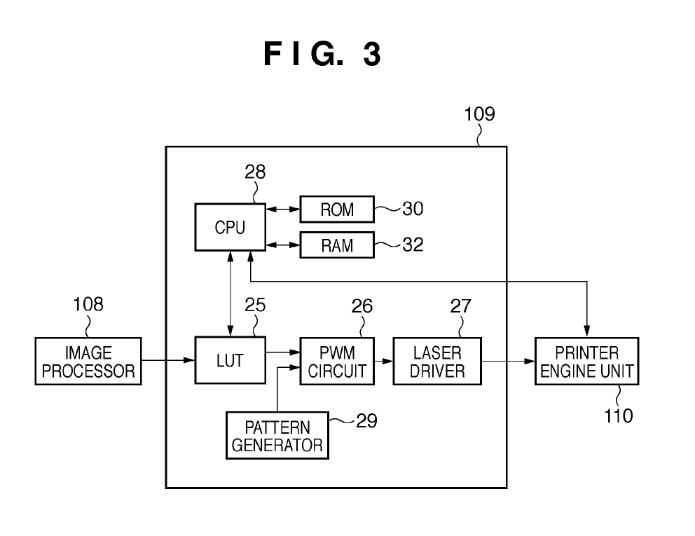

In the printer engine unit 110, the surface of a photosensitive drum (image carrier) 4, which rotates in a direction of an arrow 152, is uniformly charged by a primary charger 7. The printer controller 109 outputs, from a laser driver (a laser driver 27 in FIG. 3) to a laser light source 20, a pulse signal according to input image data. The laser light source 20 outputs a laser beam according to the input pulse signal. The laser beam output from the laser light source 20 is reflected by a polygon mirror 1 and mirror 2 to scan the uniformly charged surface of the photosensitive drum 4. In this way, an exposure unit including the laser light source 20, polygon mirror 1, and mirror 2 exposes the photosensitive drum 4 according to data input as image data of an image to be formed on a printing material, thereby forming an electrostatic latent image on the surface of the photosensitive drum 4.

In this embodiment, around the photosensitive drum 4, developers 3 (first developing units) using two-component toners (developing materials) corresponding to black (Bk), yellow (Y), cyan (C), and magenta (M) colors are arranged in turn from the upstream side along the rotational direction of the photosensitive drum 4 in the vicinity of the photosensitive drum 4. Each of these developers 3 develops an electrostatic latent image formed on the surface of the photosensitive drum 4 using a different colored toner to form a toner image (developing material image) on the photosensitive drum 4. Furthermore, on the downstream of these developers, a developer 3′ (second developing unit) corresponding to a transparent (CL) toner used to gloss an image to be formed on a printing material using the colored toners is arranged in the vicinity of the photosensitive drum 4. The developer 3′ develops an electrostatic latent image on the photosensitive drum 4 using the transparent toner to form a toner image of the transparent toner on the photosensitive drum 4.

A printing sheet P as an example of a printing material is wound around a transfer drum 5, which rotates in a direction of an arrow 153, and makes a total of five rotations according to the rotations of the transfer drum 5 in this state. In this case, toner images formed on the photosensitive drum 4 using the developers 3 and 3′ are transferred to an identical position on the printing sheet P to be superposed with each other for respective rotations. After completion of transfer of the toner images, the printing sheet P is separated from the transfer drum 5, and is fed to a fixing roller pair 6. The toner images transferred on the printing sheet P are fixed on the printing sheet P by the fixing roller pair 6. In this way, full-color print operations are complete.

Around the photosensitive drum 4, a surface potential sensor 60 used to measure an electrical potential of a surface of the photosensitive drum 4 and a cleaner 8 used to clean residual toners on the photosensitive drum 4 after transfer are arranged on the upstream side of the developers 3. A photosensor 40 is also arranged around the photosensitive drum 4. The photosensor 40 includes an LED light source 10 that irradiates toner patches formed on the photosensitive drum 4 with light, and a photodiode 11 that detects amounts of light reflected by the toner patches. Furthermore, the printer engine unit 110 includes an environment sensor 33 which measures an amount of moisture (or humidity) in air in the copying machine 100.

Image processing to be executed by the printer controller 109 of the printer unit B will be secondly described below with reference to FIG. 3. As shown in FIG. 3, the printer controller 109 applies the following image processing to an image signal (image data) received from the reader image processor 108 of the reader unit A, and outputs the processed signal to the printer engine unit 110.

To a CPU 28 of the printer controller 109, a RAM 32 and ROM 30 are connected. The ROM 30 is a nonvolatile storage device which stores, for example, control programs and control parameters required to control the overall printer unit B. The RAM 32 is a volatile storage device which is used as a work area of the CPU 28. The CPU 28 controls the overall printer unit B including the printer controller 109 and printer engine unit 110 by reading out and executing programs stored in, for example, the ROM 30 onto the RAM 32. For example, the CPU 28 controls a grid potential of the primary charger 7 and developing biases of the developers 3 and 3′ in the printer engine unit 110. Also, the CPU 28 executes, for example, a copy function by communicating with the CPU 214 of the reader unit A and executing control in cooperation with the CPU 214.

A lookup table (LUT) circuit 25 converts gradation characteristics of input image data so as to match the density of an original image when image data are obtained by reading an image from a document with that of an output image on a printing sheet when print processing is executed using the image data. The LUT circuit 25 converts the gradation characteristics using an LUT set by the CPU 28. The LUT circuit 25 includes a storage device such as a RAM so as to hold the LUT set by the CPU 28.

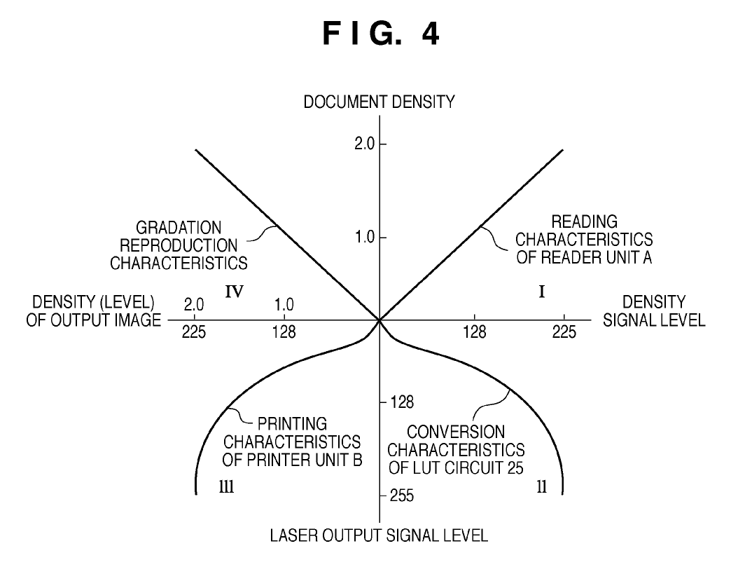

Characteristics of the copying machine 100 in respective processes from when an image of the document 101 is read until the image is reproduced on the printing sheet P will be described below with reference to FIG. 4. Referring to FIG. 4, the first (I) quadrant represents reading characteristics of the reader unit A which converts the density (document density) of the image on the document 101 into density data (density signal). The second (II) quadrant represents conversion characteristics of the LUT circuit 25 which converts the density data sent from the reader unit A to the printer unit B into a laser output signal. The third (III) quadrant represents printing characteristics of the printer unit B which converts the laser output signal into the density (output density) of an output image. Furthermore, the fourth (IV) quadrant represents the relationship between the output density by the printer unit B and the document density of the image on the document 101, and corresponds to the gradation reproduction characteristics of the overall copying machine 100. Note that when the copying machine 100 executes image processing using image data obtained by quantizing image signals into 8 bits, the number of gradations is 256, as shown in FIG. 4. Also, the document density and output density shown in FIG. 4 are measured values obtained by measuring them using a commercially available densitometer.

The copying machine 100 compensates for the nonlinear printing characteristics of the printer unit B represented by the third quadrant using the conversion characteristics of the LUT circuit 25 represented by the second quadrant, so that the gradation reproduction characteristics represented by the fourth quadrant become linear characteristics. The conversion characteristics are defined by the LUT set in the LUT circuit 25. Note that the LUT to be set in the LUT circuit 25 can be generated by executing a calibration based on a known method. Image data output from the LUT circuit 25 are input to a PWM circuit 26.

The PWM circuit 26 generates pulse signals corresponding to a dot width according to the input image data, and outputs them to a laser driver 27. The laser driver 27 ON/OFF-controls the laser light source 20 of the printer engine unit 110 in accordance with the pulse signals input from the PWM circuit 26. After that, the printer engine unit 110 forms an electrostatic latent image having predetermined gradation characteristics controlled based on changes in dot area on the photosensitive drum 4, and executes the aforementioned image formation processing (development, transfer, and fixing). Then, an original image of the document is reproduced on the printing sheet P. Note that, in this embodiment, the aforementioned gradation reproduction method based on the PWM control is used for all colors M, C, Y, and Bk.

Furthermore, in this embodiment, the CPU 28 of the printer controller 109 controls an exposure amount from the aforementioned exposure unit on the photosensitive drum 4, so as to control an amount of the transparent toner used in the development processing using the developer 3′, as will be described later. The CPU 28 controls a signal value of an image signal which is input from the reader image processor 108 of the reader unit A and corresponds to the transparent toner, thereby controlling the exposure amount on the photosensitive drum 4. That is, the CPU 28 serves as an exposure control unit.

Note that the aforementioned copying machine 100 adopts the method of directly transferring toner images respectively formed on the photosensitive drum 4 onto the printing sheet P to be superposed with each other. However, the present invention is also applicable to a copying machine using an intermediate transfer member. In this case, a plurality of toner images formed by the developers 3 and that formed by the developer 3′ are primarily transferred from the photosensitive drum 4 onto the intermediate transfer member to be superposed with each other. After completion of the primary transfer of all the toner images formed by the developers 3 and 3′ onto the intermediate transfer member, the toner images formed on the intermediate transfer member are secondarily transferred onto the printing sheet P. Even in the copying machine using such method, the same effects as those to be described below can be obtained.

<Gloss Level Control of Output Image>

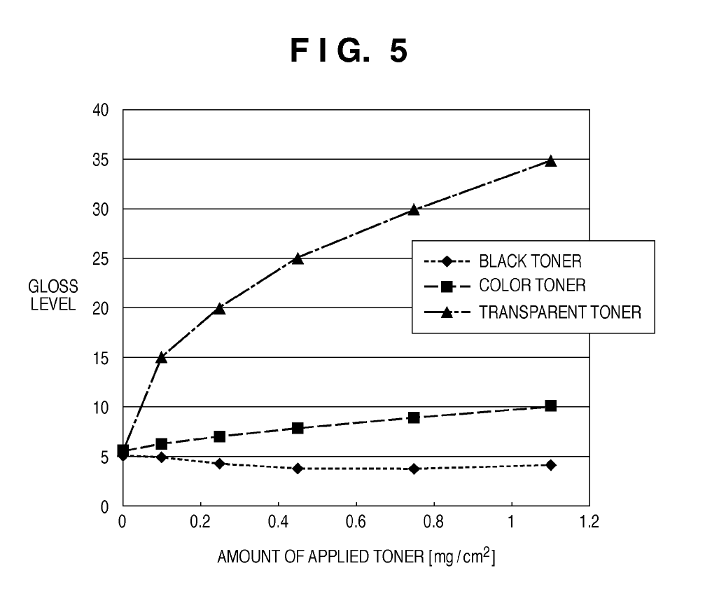

In the copying machine 100, depending on the toners used in development, gloss levels are often different for respective pixels on an image (output image) formed on the printing sheet P by the printer unit B. In this case, FIG. 5 shows an example of the relationship between the amount of applied toner per unit area and the gloss level when the development processes are performed respectively using the black toner (Bk), color toners (Y, M, C), and transparent toner (CL). Note that in FIG. 5, plain paper is used as a printing material. In this embodiment, assume that the color toners include the Y, M, and C toners, and the black toner is not included. As can be seen from FIG. 5, a pixel to be developed using only the black toner has a lower gloss level than a pixel to be developed using the color toners other than the black toner. In this case, when an image including both pixels to be developed using the color toners and those to be developed using the black toner alone is formed on a printing material, gloss levels for respective pixels on the formed image are caused to be nonuniform. Due to such gloss level nonuniformity, an unnatural image for the user who views the formed image may be unwantedly formed. Thus, in this embodiment, the transparent toner is added, by a predetermined amount, to a pixel that has been formed using the black toner alone, thus reducing the gloss level nonuniformity of the entire output image, as will be described below.

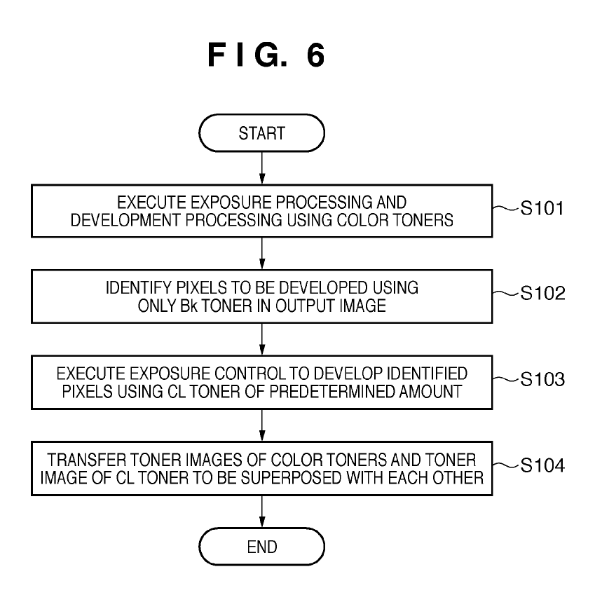

The image formation sequence in the printer unit B of the copying machine 100 will be described below with reference to FIG. 6. The printer controller 109 of the printer unit B receives an image signal of an image to be formed on a printing sheet P from the reader image processor 108. This image signal includes a plurality of image signals corresponding to a plurality of color toners (M, C, Y, Bk). After that, in step S101, the printer controller 109 controls the printer engine unit 110 using the received image signal to form toner images of respective colors on the printing sheet P to be superposed with each other. More specifically, the printer controller 109 inputs pulse signals to the exposure unit according to the received image signal so as to expose the surface of the photosensitive drum 4. Thus, an electrostatic latent image is formed on the photosensitive drum 4. The developers 3 corresponding to M, C, Y, and Bk color toners develop corresponding electrostatic latent images formed on the photosensitive drum 4 to form toner images in turn on the photosensitive drum 4 under the control of the printer controller 109. These toner images are transferred from the photosensitive drum 4 to the printing sheet P on the transfer drum 5 in turn to be superposed with each other. After that, the control advances to step S102.

In step S102, the printer controller 109 identifies pixels to be developed using only the black toner of the plurality of color toners from the received image signal, so as to decide pixels to be glossed using the transparent toner. For example, the printer controller 109 can identify pixels for which only an image signal corresponding to the black toner, of the received image signals corresponding to the respective colors, is input to the exposure unit, as those to be developed using only the black toner. After that, the control advances to step S103.

In step S103, the printer controller 109 controls the exposure amount by the exposure unit so as to develop the pixels identified in step S102 using the transparent toner of a predetermined amount by the developer 3′ corresponding to the transparent toner. In this case, the printer controller 109 sets the amount of the transparent toner used in development to be an amount that reduces a gloss level difference between pixels to be developed using only the black toner and those to be developed using the color toners other than the black toner. This control in step S103 is intended to attain uniform gloss levels of the pixels to be developed using only the black toner and those to be developed using the color toners other than the black toner.

The amount of the transparent toner used by the developer 3′ can be decided based on, for example, the relationship shown in FIG. 5, which is measured in advance in association with the copying machine 100. As can be understood from FIG. 5, a maximum difference between gloss levels of the color toners and black toner is about 6, and an amount of applied transparent toner required to reduce or eliminate that difference is about 0.07 (mg/cm²). In this case, the printer controller 109 can decide the amount of the transparent toner used in the developer 3′ to be 0.07 (mg/cm²). In this way, the required amount of the transparent toner can be decided based on the measured values of gloss levels, which are measured in advance. The decided value may be stored in advance in, for example, the ROM 30, and the CPU 28 may read out the value as needed and may use it in the exposure control in step S103.

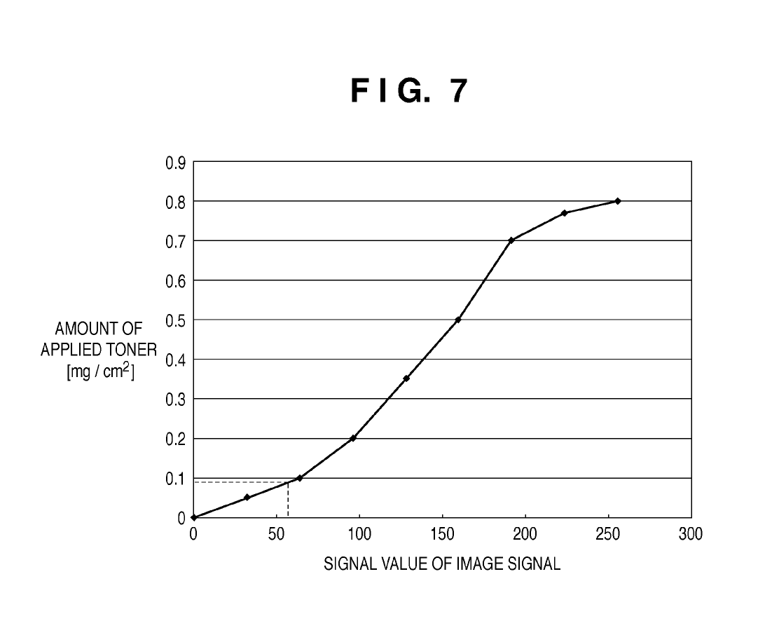

Also, the printer controller 109 can set a signal value of the image signal, which is to be input to the exposure unit and corresponds to the transparent toner, to be that corresponding to the amount of the transparent toner, so as to realize the exposure amount control according to the required amount of the transparent toner in the developer 3′. FIG. 7 shows an example of the relationship between the signal value of an image signal corresponding to the transparent toner and the amount of applied transparent toner. Note that the values shown in FIG. 7 are measured in advance using the copying machine 100, and signal values of an image signal have an 8-bit gradation range (0 to 255). As can be seen from FIG. 7, a signal value required to achieve the amount of applied transparent toner=0.07 (mg/cm²) is about 60. The signal value of the image signal required for the exposure control can be decided in advance in this way, and the decided value may be pre-stored in, for example, the ROM 30. Thus, the CPU 28 may read out the stored value as needed and may use that value in the exposure control in step S103.

An electrostatic latent image according to the signal value of the image signal, which is set as described above, is formed on the photosensitive drum 4 under the exposure control by the printer controller 109 in step S103. The developer 3′ develops the electrostatic latent image using the transparent toner, thereby forming a toner image by the predetermined amount of the transparent toner on the photosensitive drum 4. After that, the control advances to step S104.

In step S104, the printer controller 109 controls the printer engine unit 110 to transfer the toner image of the transparent toner from the photosensitive drum 4 onto the printing sheet P. The printer engine unit 110 transfers the toner image of the transparent toner onto the printing sheet P wound around the transfer drum 5, so that the toner image of the transparent toner is superposed on those of the color toners already transferred onto the printing sheet P. After that, the toner images on the printing sheet P are fixed on the printing sheet P by the fixing roller pair 6. In this manner, the transparent toner of the predetermined amount is added to be superposed on the pixels developed using only the black toner in the toner images of the color toners. Then, the transparent toner of the required amount is attached and fixed to only the pixels using only the black toner on the image formed on the printing sheet P.

As described above, the copying machine 100 according to the first embodiment, when forming an image using the transparent toner, identifies pixels to be developed using only the black toner of the colored toners from image signals of an image to be formed on a printing material. Furthermore, the copying machine 100 executes the exposure control for the identified pixels so as to perform development using the transparent toner in an amount that can reduce a gloss level difference between pixels to be developed using only the black toner and those to be developed using the colored toners other than the black toner. Finally, the toner image formed using the transparent toner is transferred onto the printing material to be superposed on those formed using the colored toners. Accordingly, regions having different gloss levels as a result of image formation using the transparent toner can be prevented from being generated on the image fixed on the printing material, and the entire image can have a uniform gloss level. Furthermore, a natural image for the user who views the image can be formed by attaining a uniform gloss level of the entire image.

### Second Embodiment

The first embodiment assumes the case in which an amount of a transparent toner used in a developer 3′ is fixedly set to form an image using the transparent toner. However, printing materials themselves to be used in image formation often have different gloss levels depending on their types. In this case, the amount of the transparent toner required to attain a uniform gloss level on an output image onto a printing material changes. Hence, the second embodiment will explain an embodiment in which the amount of the transparent toner to be used is controlled in accordance with the measurement result of a gloss level of a printing material to be used. Note that only differences from the first embodiment will be explained below to simplify the following description.

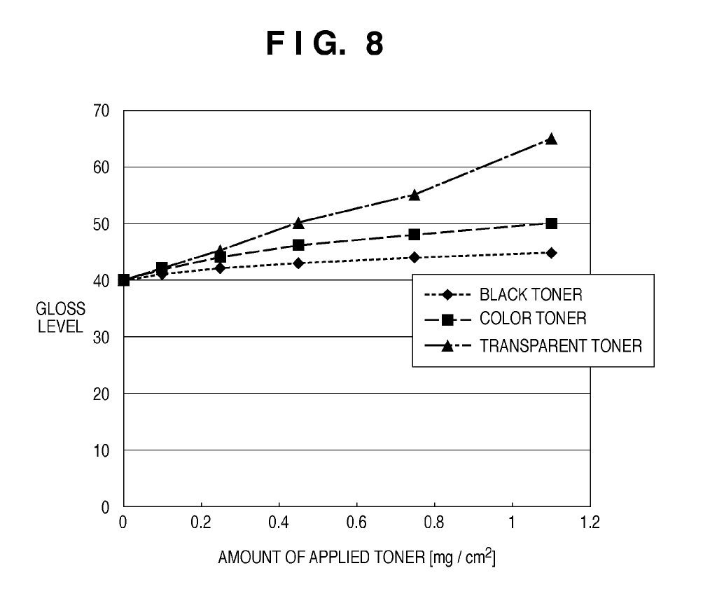

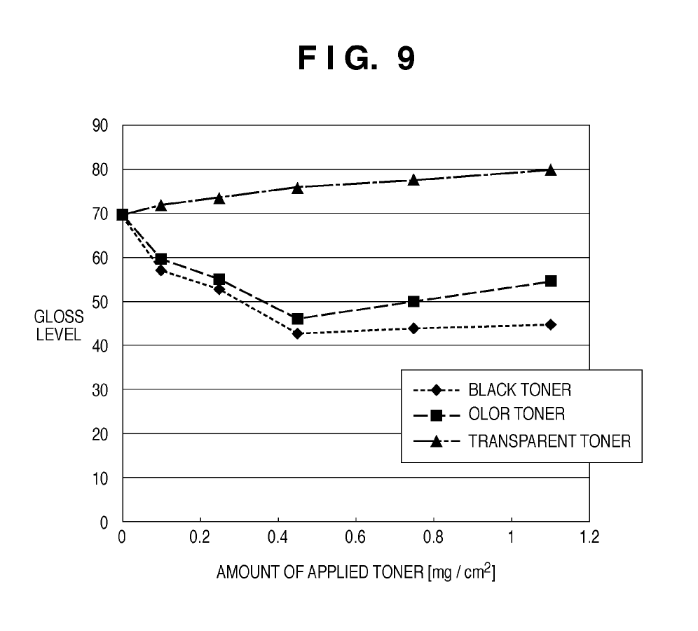

Gloss level differences depending on printing materials will be described first with reference to FIGS. 8 and 9. In this case, FIGS. 8 and 9 show examples when coated paper and cast-coated paper are used in place of the plain paper in FIG. 5. Note that the coated paper has a gloss level higher than the plain paper, and the cast-coated paper has a gloss level higher than the coated paper. As can be seen from FIGS. 8 and 9, when gloss levels of printing materials are different, mutual relationships between gloss levels in case of development using only the black toner and in case of development using the color toners other than the black toner change from that in FIG. 5 of the first embodiment. For this reason, in order to attain a uniform gloss level on the entire output image, the amount of the transparent toner used in the developer 3′ has to be appropriately set according to a gloss level of a printing material to be used.

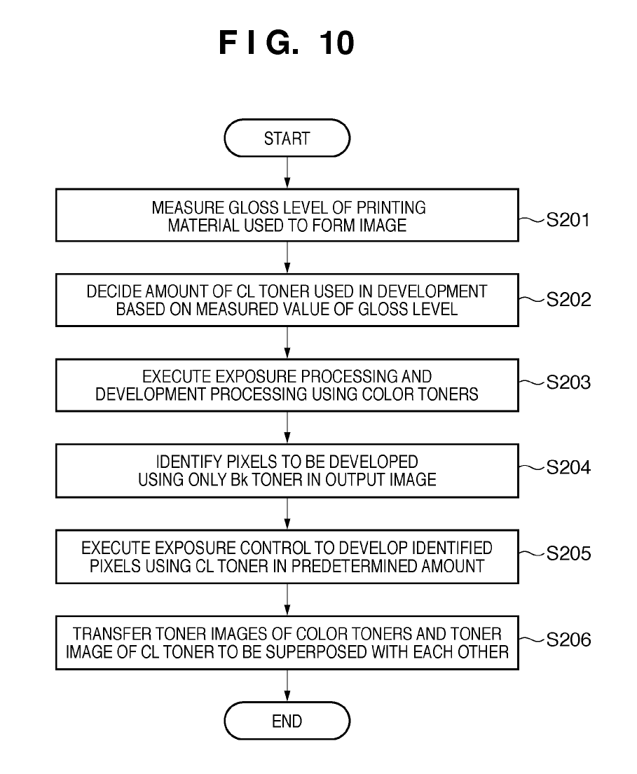

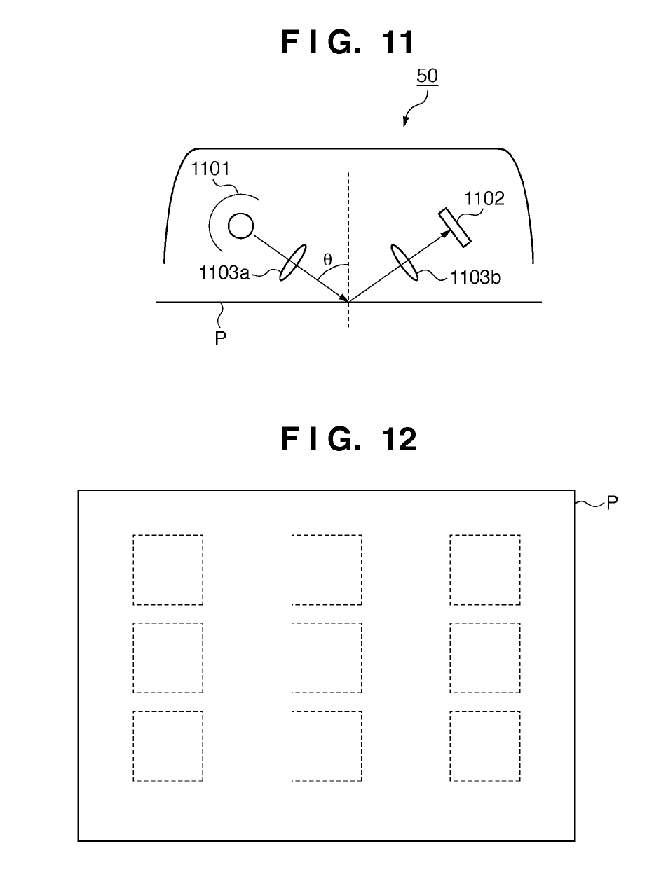

The image formation sequence in a printer unit B of a copying machine 100 according to this embodiment will be described below with reference to FIG. 10. Note that, since processes in steps S203 to S206 are the same as those in steps S101 to S104 in the first embodiment, steps S201 and S202 will be mainly described. When printing materials are set in a paper feed unit (not shown in FIG. 1), and user starts image formation, a printer controller 109 measures a gloss level of the printing material using a gloss level measurement unit 50 included in the printer unit B in step S201. FIG. 11 shows an example of the arrangement of the gloss level measurement unit 50, that is, an arrangement which performs measurement by a method specified in JISZ8741. In this case, the gloss level measurement unit 50 inputs a light beam having a prescribed aperture angle at a constant incident angle θ to the surface of a printing material P. The gloss level measurement unit 50 then measures, using a light-receiving unit, the light beam having the prescribed aperture angle, which is reflected by the printing material P in a specular reflection direction. More specifically, a light beam emitted by a light source 1101 passes through a lens 1103a and becomes incident on the printing material P at the angle θ. Then, a light-receiving unit 1102 measures the light beam which is reflected by the printing material P in the specular reflection direction via a lens 1103b.

Also, the gloss level measurement unit 50 may irradiate a plurality of different positions on the printing material P with a light beam emitted by the light source 1101, and may measure reflected light beams from the plurality of positions received by the light-receiving unit 1102. For example, the gloss level measurement unit 50 may irradiate nine different measurement positions on the printing material P with light, as shown in FIG. 12. In this case, the printer controller 109 may measure the gloss level of the printing material P by averaging the plurality of obtained measured values. In this way, the gloss level measurement unit 50 and printer controller 109 serve as a measurement unit.

Note that the gloss level measurement unit 50 may be arranged in a reader unit A in place of the printer unit B. In this case, a printing material to be used in image formation may be set on a platen glass 102 of the reader unit A to measure its gloss level in advance, and the measured value may be sent to and used by the printer controller 109. An arbitrary image pattern used to measure a gloss level may be formed in advance on a printing material P used to measure the gloss level. In this case, the printer unit B may form that image pattern on the printing material P in advance.

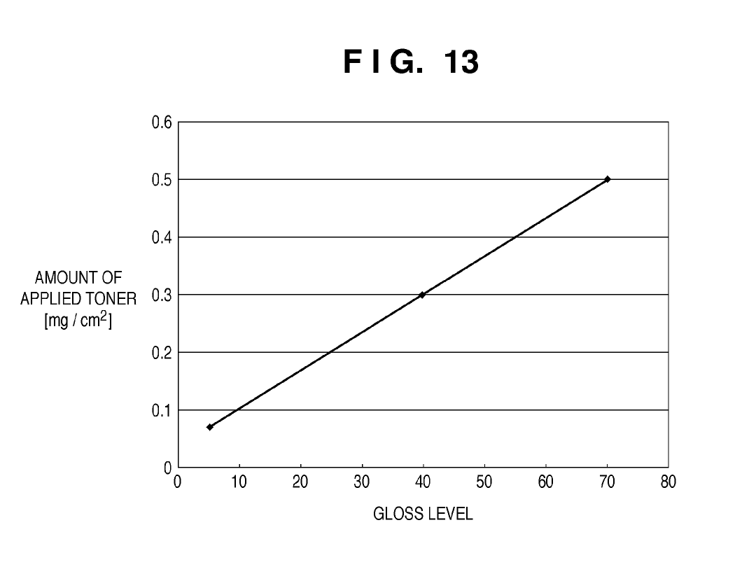

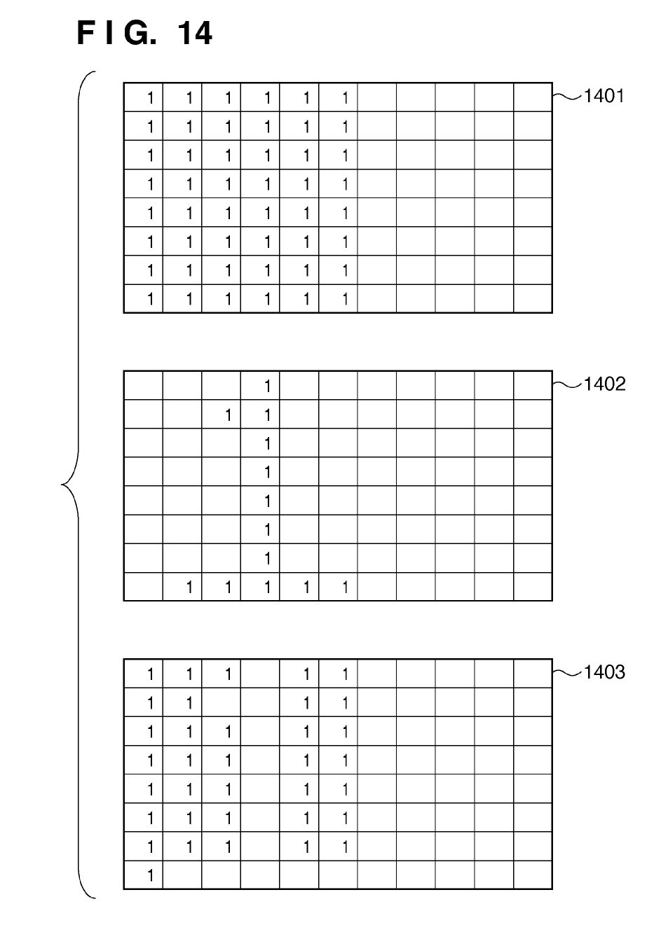

In step S202, the printer controller 109 decides a toner amount of the transparent toner used in the developer 3′ based on the measured value of the gloss level measured in step S201. In this case, the printer controller 109 decides the toner amount based on a table pre-stored in a storage device such as a ROM 30. The table includes data indicating the relationship between gloss levels of printing materials and the corresponding amounts of the transparent toner required for pixels to be developed using only the black toner, for example as shown in FIG. 13. Note that the data of the table can be obtained by measuring gloss levels of a plurality of types of printing materials in advance, and deciding required amounts of applied transparent toner based on these measured values. The required amount of applied transparent toner may be that required to reduce a gloss level difference between pixels to be developed using only the black toner and those to be developed using the color toners other than the black toner, as in the first embodiment. In this way, data may be obtained in association with a plurality of different gloss levels, and may be stored in, for example, the ROM 30. Then, a CPU 28 may read out and use the stored value as needed.

The printer controller 109 obtains the amount of the transparent toner corresponding to the gloss level measured in step S201 with reference to the table stored in, for example, the ROM 30, and decides the obtained value as the toner amount of the transparent toner used in the developer 3′. After that, the printer controller 109 executes the processes in step S203 and subsequent steps. Note that the printer controller 109 controls the amount of the transparent toner used in the developer 3′ by executing exposure control by setting a signal value of an image signal which is to be input to an exposure unit and corresponds to the transparent toner to be that corresponding to the required amount of the transparent toner, as described above. For this reason, the table actually stored in the storage unit such as the ROM 30 need only include correspondence data between gloss levels of printing materials and signal values to be input to the exposure unit.

As described above, in the copying machine 100 according to this embodiment, even when a gloss level changes depending on a printing material to be used, the overall output image is enabled to have a uniform gloss level. Note that this embodiment allows various modifications. For example, the printer controller 109 may set the required amount of the transparent toner in accordance with a type of a printing medium which is set by the user via an operation unit 217, without measuring a gloss level for each image formation. In this case, correspondence data between types of printing materials and required amounts of the transparent toner may be stored in the storage device such as the ROM 30, and the printer controller 109 may decide the amount of the transparent toner used in development with reference to the correspondence data.

### Third Embodiment

In the first and second embodiments, a printer controller 109 executes processing for identifying pixels to be developed using only a black toner in an output image, and applying a transparent toner to the identified pixels, thereby attaining a uniform gloss level of the entire image. However, when an output image includes a text part to be formed by the black toner alone, if the text part is glossed by the transparent toner, its visibility may lowers. Hence, the third embodiment will explain an embodiment in which development using the transparent toner is performed except for a detected text part, so as to prevent the visibility from lowering while attaining a uniform gloss level of the output image. Note that only differences from the first and second embodiments will be described below to simplify the following description.

Image formation processing according to this embodiment can be implemented by modifying FIG. 6 of the first embodiment or FIG. 10 of the second embodiment. More specifically, the printer controller 109 need only further detect pixels included in a text/line drawing part from identified pixels to be developed using only the black toner in step S102 (S204). Such detection of a text/line drawing part can be implemented by a known method. After that, the control advances to step S103 (S205).

In step S103 (S205), the printer controller 109 controls an exposure amount of an exposure unit so as to develop, by a developer 3′, pixels of those identified in step S102 (S204) except for the detected pixels corresponding to a text/line drawing part. For example, in FIG. 14, parts “1” included in an image 1401 indicate pixels to be developed using only the black toner, and parts “1” included in an image 1402 indicate pixels included in a text part. In this case, signal values of an image signal to be output from the printer controller 109 to the exposure unit are set so that only parts “1” in an image 1403 obtained by excluding the parts “1” in the image 1402 from the image 1401 are to be developed using the transparent toner.

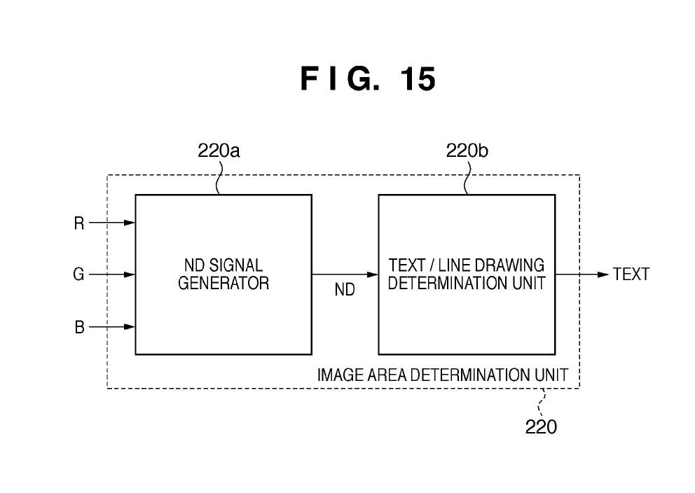

Note that pixels included in a text/line drawing part included in an output image may be detected by an image area determination unit 220 of a reader image processor 108 in place of the printer controller 109. In this case, the image area determination unit 220 has an arrangement shown in, for example, FIG. 15. In the arrangement of FIG. 15, an ND signal generator 220a of the image area determination unit 220 generates, based on input image signals of RGB color components, an ND signal as a lightness signal that considers human visibility characteristics. Furthermore, a text/line drawing determination unit 220b extracts a text/line drawing part from the input ND signal, and generates and outputs a determination signal TEXT in which a value “1” is set for pixels of the text/line drawing part and a value “0” is set for other pixels. The reader image processor 108 can append this determination signal TEXT to the image signals, and can send the image signals to the printer controller 109. The printer controller 109 can detect the text/line drawing part using the received determination signal TEXT.

As described above, a copying machine 100 according to this embodiment executes development processing using the transparent toner by excluding pixels included in a detected text/line drawing part from identified pixels to be developed using only the black toner. Thus, the visibility of a text can be prevented from lowering while attaining a uniform gloss level of the entire output image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-039200, filed Feb. 24, 2010, which is hereby incorporated by reference herein in its entirety.

What is claimed is:

1. An image forming apparatus comprising:
an image carrier;
an exposure unit that exposes said image carrier in accordance with an image signal of an image to be formed on a printing material to form an electrostatic latent image on said image carrier;
a plurality of first developing units that respectively develop the electrostatic latent images using different colored developing materials to form developing material images on said image carrier;
a second developing unit that develops the electrostatic latent image using a transparent developing material, which is used to gloss an image to be formed on the printing material using the colored developing materials, to form a developing material image on said image carrier;
an identifying unit that identifies, from the image signal, pixels to be developed using only a black developing material of the plurality of colored developing materials;
an exposure control unit that controls an exposure amount of said exposure unit so as to develop the identified pixels by said second developing unit using the transparent developing material in an amount required to reduce a gloss level difference between the pixels to be developed using only the black developing material and pixels to be developed using the colored developing materials other than the black developing material; and
a transfer unit that transfers a plurality of developing material images formed by said plurality of first developing units and a developing material image formed by said second developing unit from said image carrier to the printing material to be superposed with each other.

2. The apparatus according to claim 1, wherein the image signal includes a plurality of image signals corresponding to the plurality of colored developing materials, and
said identifying unit identifies pixels for which only the image signal corresponding to the black developing material of the plurality of image signals is input to said exposure unit as the pixels to be developed using only the black developing material.

3. The apparatus according to claim 1, wherein said exposure control unit controls the exposure amount of said exposure unit by setting a signal value of an image signal which is to be input to said exposure unit and corresponds to the transparent developing material to be a signal value corresponding to the amount of the transparent developing material used by said second developing unit.

4. The apparatus according to claim 1, further comprising:
a storage unit that stores a table including a relationship between gloss levels of a plurality of printing materials, and amounts of the transparent developing material required for the identified pixels corresponding to the respective gloss levels of the plurality of printing materials;
a measurement unit that measures a gloss level of the printing material used to form an image; and
a decision unit that obtains, from the table stored in said storage unit, an amount of the transparent developing material corresponding to the measured gloss level, and decides the obtained amount of the transparent developing material as the amount of the transparent developing material to be used by said second developing unit.

5. The apparatus according to claim 4, further comprising:
a light source that irradiates the printing material with light; and
a light-receiving unit which receives reflected light that is irradiated from said light source and is reflected by the printing material,
wherein said measurement unit measures the gloss level of the printing material by irradiating a plurality of different positions on the printing material with light beams from said light source, and averaging measured values of the light beams which are reflected from the plurality of positions and are received by said light-receiving unit.

6. The apparatus according to claim 1, further comprising:
a detection unit that detects pixels included in a text or line drawing part from the pixels identified by said identifying unit,
wherein said exposure control unit controls said exposure unit so that pixels obtained by excluding the detected pixels from the identified pixels are to be developed by said second developing unit.

7. The apparatus according to claim 1, further comprising an intermediate transfer member,
wherein said transfer unit comprises:
a first transfer unit that transfers the plurality of developing material images formed by said plurality of first developing units and the developing material image formed by said second developing unit from said image carrier to said intermediate transfer member to be superposed with each other; and
a second transfer unit that transfers the developing material images which are transferred to said intermediate transfer member to be superposed with each other onto the printing material.

8. A control method of an image forming apparatus which comprises an image carrier, an exposure unit that exposes the image carrier in accordance with an image signal of an image to be formed on a printing material to form an electrostatic latent image on the image carrier, a plurality of first developing units that respectively develop the electrostatic latent images using different colored developing materials to form developing material images on the image carrier, and a second developing unit that develops the electrostatic latent image using a transparent developing material, which is used to gloss an image to be formed on the printing material using the colored developing materials, to form a developing material image on the image carrier, the method comprising:
identifying, from the image signal, pixels to be developed using only a black developing material of the plurality of colored developing materials;
controlling an exposure amount of the exposure unit so as to develop the identified pixels by the second developing unit using the transparent developing material in an amount required to reduce a gloss level difference between the pixels to be developed using only the black developing material and pixels to be developed using the colored developing materials other than the black developing material; and
transferring a plurality of developing material images formed by the plurality of first developing units and a developing material image formed by the second developing unit from the image carrier to the printing material to be superposed with each other.
